(19) United States
(12) Patent Application Publication
(10) Pub. No.: US 2019/0299103 A1
(43) Pub. Date: Oct. 3, 2019

(54) SYSTEM AND METHOD FOR UPDATING AN APPLICATION CLIENT

(71) Applicant: MZ IP Holdings, LLC, Palo Alto, CA (US)

(72) Inventor: Stanley Lee, Fremont, CA (US)

(21) Appl. No.: 16/274,651

(22) Filed: Feb. 13, 2019

Related U.S. Application Data
(60) Provisional application No. 62/649,639, filed on Mar. 29, 2018.

(51) Int. Cl. A63F 13/79; A63F 13/65; G06Q 50/00

(52) U.S. Cl. CPC A63F 13/79; G06Q 50/01; A63F 13/65

(57) ABSTRACT

Implementations of the present disclosure are directed to a method, a system, and an article for updating a computer game or other application client using social media data for one or more users. An example method can include: providing, on a client device, a computer game having a set of gameplay characteristics; obtaining information about a user of the client device from a social media provider; determining at least one condition of the user based on the obtained information; modifying at least one of the gameplay characteristics according to the at least one condition; and providing, on the client device, a modified version of the computer game including the at least one modified gameplay characteristic.

### CROSS-REFERENCE TO RELATED APPLICATIONS

This application claims the benefit of U.S. Provisional Patent Application No. 62/649,639, filed Mar. 29, 2018, the entire contents of which are incorporated by reference herein.

### BACKGROUND

The present disclosure relates to application clients and, in some examples, to systems and methods for updating an application client for a multi-player online game according to automatic retrieval and processing of online user data.

In general, a multi-player online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players.

In a typical example, a player interacts with the virtual environment by providing input to a user input device. Common user input devices for games can include, for example, a touch screen, a keypad, a joystick, and/or a keyboard. With a touch screen, users can interact with the virtual environment by tapping or selecting items displayed on the screen.

### SUMMARY

In general, the systems and methods described herein relate to modifying or customizing online games and other software applications based on information obtained about users of the applications from social media. In a typical example, on online game is configured to obtain social media information (e.g., user profile information or live social media data) for a user, for example, based on the user's social media profile or social media activity (e.g., messages, likes, friends, and/or followers). The social media information is used to determine at least one condition of the user (e.g., popularity, sentiment, health, etc.), and a gameplay characteristic of the online game is modified according to the at least one condition. A modified version of the online game that includes the modified gameplay characteristic is then provided to the user. Advantageously, the approach of modifying gameplay according to the user condition can significantly improve the user's connection to the game and overall user interest in the game. The approach can also improve computer functionality by providing virtual environments that more closely resemble the user's environment or condition. The approach can allow user conditions to be determined and corresponding updates to the online game or other application client to be made at or near real-time (e.g., using a publish-subscribe system).

In some instances, for example, use of social media information can improve user engagement with an online game by connecting users with other users who are contacts or friends in social media. Such users can be introduced to one another and/or encouraged to interact with one another in a common virtual environment. Alternatively or additionally, the users can be encouraged to form teams that compete in the online game with other teams. Such affiliations with other users from the same social media network can result in more user enjoyment and/or satisfaction with the online game.

In one aspect, the subject matter described in this specification relates to a computer-implemented method. The method includes: providing, on a client device, a computer game having a set of gameplay characteristics; obtaining information about a user of the client device from a social media provider; determining at least one condition of the user based on the obtained information; modifying at least one of the gameplay characteristics according to the at least one condition; and providing, on the client device, a modified version of the computer game having the at least one modified gameplay characteristic.

In certain examples, the client device can be or include a mobile device and/or a gaming console. The gameplay characteristics can be or include a game rule, a game challenge, a game plot, a virtual item, a game character, a user ability, or any combination thereof. Obtaining the information can include subscribing to a channel of a publish-subscribe system. The information can include at least one of live social media data or social media profile data. The step of determining the at least one condition can be performed periodically. The at least one condition of the user can be or include an anniversary, a birthday, a geographical location, a physical condition, an emotional state, an opinion, an attitude, a social media popularity, or any combination thereof.

In some instances, modifying at least one of the gameplay characteristics can include at least one of: (i) presenting the user with a new challenge in the computer game; (ii) modifying an ability of the user to interact with a virtual environment of the computer game; (iii) modifying at least one of an availability, a type, and a cost of a virtual item in the computer game; (iv) modifying at least one of a frequency and a type of virtual characters in the computer game; or (v) providing a new graphical representation to enhance the virtual environment of the computer game. The method can include updating a display of the computer game on the client device according to the determined at least one condition. Additionally or alternatively, the method can include receiving permission from the user of the client device to modify the at least one of the gameplay characteristics according to the at least one condition.

In another aspect, the subject matter described in this specification relates to a system. The system includes one or more computer processors programmed to perform operations that include: providing, on a client device, a computer game having a set of gameplay characteristics; obtaining information about a user of the client device from a social media provider; determining at least one condition of the user based on the obtained information; modifying at least one of the gameplay characteristics according to the at least one condition; and providing, on the client device, a modified version of the computer game having the at least one modified gameplay characteristic.

In various implementations, the client device can be or include a mobile device and/or a gaming console. The gameplay characteristics can be or include a game rule, a game challenge, a game plot, a virtual item, a game character, a user ability, or any combination thereof. Obtaining the information can include subscribing to a channel of a publish-subscribe system. The information can include at least one of live social media data or social media profile data. The step of determining the at least one condition can be performed periodically. The at least one condition of the user can be or include an anniversary, a birthday, a geographical location, a physical condition, an emotional state, an opinion, an attitude, a social media popularity, or any combination thereof.

In some examples, modifying at least one of the gameplay characteristics can include at least one of: (i) presenting the user with a new challenge in the computer game; (ii) modifying an ability of the user to interact with a virtual environment of the computer game; (iii) modifying at least one of an availability, a type, and a cost of a virtual item in the computer game; (iv) modifying at least one of a frequency and a type of virtual characters in the computer game; or (v) providing a new graphical representation to enhance the virtual environment of the computer game. The operations can include updating a display of the computer game on the client device according to the determined at least one condition. Additionally or alternatively, the operations can include receiving permission from the user of the client device to modify the at least one of the gameplay characteristics according to the at least one condition.

In another aspect, the subject matter described in this specification relates to an article. The article includes a non-transitory computer-readable medium having instructions stored thereon that, when executed by one or more computer processors, cause the computer processors to perform operations that include: providing, on a client device, a computer game having a set of gameplay characteristics; obtaining information about a user of the client device from a social media provider; determining at least one condition of the user based on the obtained information; modifying at least one of the gameplay characteristics according to the at least one condition; and providing, on the client device, a modified version of the computer game having the at least one modified gameplay characteristic.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### DESCRIPTION OF THE DRAWINGS

FIG. 1 is a schematic diagram of an example system for updating an application client based on social media information.

FIG. 2 is a schematic data flow diagram of a method of obtaining social media data for an application client.

FIG. 3 is a schematic data flow diagram of a method of obtaining social media data for an application client.

FIG. 4 is a schematic data flow diagram of a method of using a publish-subscribe system to obtain social media data for an application client.

FIG. 5 is a schematic data flow diagram of a method of using a publish-subscribe system to obtain social media data for an application client.

FIG. 6 is a flowchart of an example method of updating an application client based on social media information.

### DETAILED DESCRIPTION

In general, the systems and methods described herein can be used to update or customize an application client, such as, for example, a massively multiplayer online game client, using information that the application client obtains about a user (alternatively referred to herein as a “player”) of the application client. The application client can obtain the information (referred to herein as “user information”) from suitable online sources, such as social media sites (e.g., FACEBOOK, INSTAGRAM, SNAPCHAT, and/or TWITTER), for example, using public application programming interfaces (APIs) provided by the social media sites. In some examples, the user information can be or include user profile information and/or live social media data. The user profile information can be or include data that defines user characteristics and is not necessarily shared with other users, such as, for example, birth date, address, and/or demographic information (e.g., age or gender). The live social media information can be or include data that is generated by user activity and is typically shared with one or more other social media users, such as, for example, messages (e.g., text messages or emoji), images, social media likes, and/or number of social media contacts, friends, or followers. Live social media information is preferably obtained by the systems and methods described herein as soon as it is generated by the user (e.g., using the publish-subscribe approach described herein). By obtaining such user profile information and live social media information, the application client can provide a different or customized application experience to the user. In the context of a multiplayer online game, for example, the application can provide updated graphical or visual representations, game features, game rules, game events, and game functionalities. The application is preferably able to retrieve the user information and update the application in real-time or close to real-time (e.g., within seconds or minutes of the user information being made available on an online source).

In various implementations, the systems and methods utilize a backend application server (e.g., a backend game server), an application client (e.g., a game client), and one or more online or otherwise networked information sources. The backend application server can host an application model and logic required for interacting with or otherwise using the application client running on the user's client device. The user can utilize the application client to interact with the backend application server (e.g., via the Internet) to support the user's interaction with the application client. The online sources can be or include, for example, facebook.com, twitter.com, and/or any other suitable web-related or internet-connected social media-related services, from which the backend application server can retrieve social media information relevant to the user.

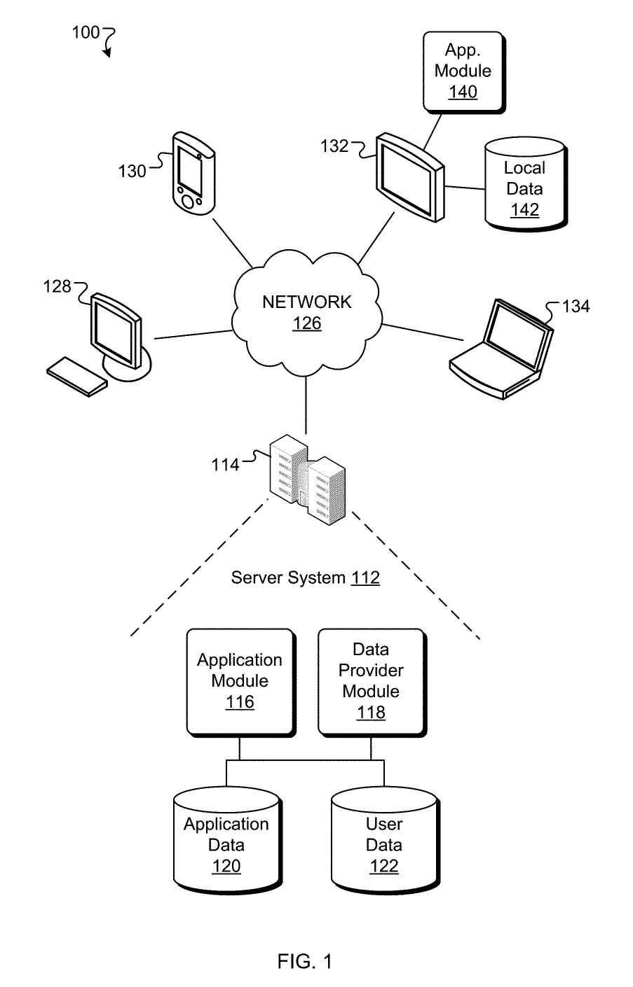

FIG. 1 illustrates an example system 100 for updating an application client based on information obtained about a user of the application client. A server system 112 provides functionality for providing the application client on the user's client device, retrieving the user information from one or more online sources, and updating or customizing the application client according to the information. The server system 112 includes software components and databases that can be deployed at one or more data centers 114 in one or more geographical locations, for example. The server system 112 software components can include an application module 116 and a data provider module 118. The software components can include subcomponents that can execute on the same or on different individual data processing apparatus. The server system 112 databases can include an application data 120 database and a user data 122 database. The databases can reside in one or more physical storage systems. The software components and data will be further described below.

The application client, such as, for example, a client-based and/or web-based software application, can be provided as an end-user application to allow users to interact with the server system 112. The application client can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the application client provides a computer game, such as a multiplayer online game. The application client or components thereof can be accessed through a network 126 (e.g., the Internet) by users of client devices, such as a personal computer 128, a smart phone 130 (or similar mobile device), a tablet computer 132, and a laptop computer 134. Other client devices are possible. In alternative examples, the application data 120 and/or the user data 122 or any portions thereof can be stored on one or more client devices. Additionally or alternatively, software components for the system 100 (e.g., the application module 116 and/or the data provider module 118) or any portions thereof can reside on or be used to perform operations on one or more client devices.

Each client device in the system 100 can utilize or include software components and/or databases for the application client. The software components on the client devices can include an application module 140, which can implement or provide the application client on each client device (e.g., the application module 140 can be the application client or portions thereof). The databases on the client devices can include a local data 142 database, which can store data for the application client and exchange the data with the application module 140 and/or with other software components for the system 100, such as the application module 116. The data stored on the local data 142 database can include, for example, user history data, user transaction data, user social media data, demographic data, user preferences, image data, video data, audio data, and/or any other data used or generated by the system 100. While the application module 140 and the local data 142 database are depicted as being associated with the tablet computer 132, it is understood that other client devices (e.g., the personal computer 128, the smart phone 130, and/or the laptop computer 134) can include the application module 140, the local data 142 database, or any portions thereof.

FIG. 1 depicts the application module 116 and the data provider module 118 as being able to communicate with the application data 120 database and the user data 122 database. The application data 120 database generally includes information related to the application client (e.g., a multi-player online game) implemented using the system 100. The application data 120 database can include, for example, information related to a virtual environment, image, video and/or audio data, event data corresponding to previous, current or future events, and/or application state data (e.g., defining a current state of an online game). The user data 122 database generally includes data related to users and user interactions with the application client. Such information can be or include, for example, information related to user preferences, user demographics, social media data, user messages, a history of user connections to the system 100, user purchases, user geographical locations, user accomplishments, user tasks, user interactions with other users (e.g., group chats), user virtual item acquisition or usage, and/or other user conditions in the virtual environment and/or real world.

In various examples, the application client can provide an online game and the users or players of the online game can have certain user capabilities in a virtual environment. The user capabilities can be or include, for example, moving an avatar or a virtual item or object to a different geographical or spatial location, interacting with characters or other users, participating in user groups or alliances, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible. The virtual environment for the online game can be rendered for users in the form of, for example, graphics, images, video, audio, text, and/or haptic feedback. In an adventure game, for example, a graphical user interface can display a virtual environment that includes representations of characters (e.g., people or animals), natural features (e.g., mountains, rivers, fields, trees, and/or weather conditions), and/or man-made features (e.g., buildings, bridges, and/or vehicles).

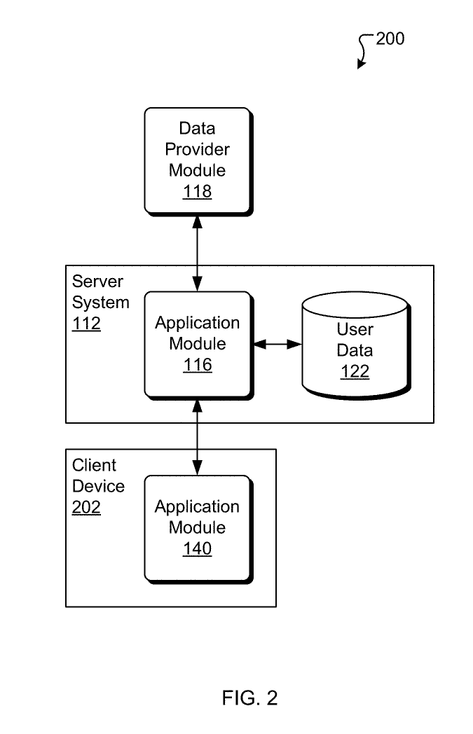

FIG. 2 is a schematic data flow diagram of a method 200 in which the application module 116, the data provider module 118, and the application module 140 are used to customize the application client according to information related to the user. The application module 116 (e.g., an application server or a backend application server) and the application module 140 provide the application client to a user of a client device 202 (e.g., the tablet computer 132). The application module 116 obtains user information from the data provider module 118, which can be or include a social media provider or component thereof In some instances, the application module 116 can request user information and the data provider module 118 can provide the user information in response to the request. The user information received by the application module 116 from the data provider module 118 can be stored in the user data 122 database and can be provided to the application module 140. The application module 140 can request the user information, for example, by making a suitable query to the application module 116. The application module 116 and/or the application module 140 can update or customize the application client according to the user information, as described herein. In a typical example, the data provider module 118 is a social media service provider, a social media data provider, a social media website, and/or a component (e.g., an API) used to retrieve user information from a social media service. The user information provided by the data provider module 118 can be or include public information and/or non-public information.

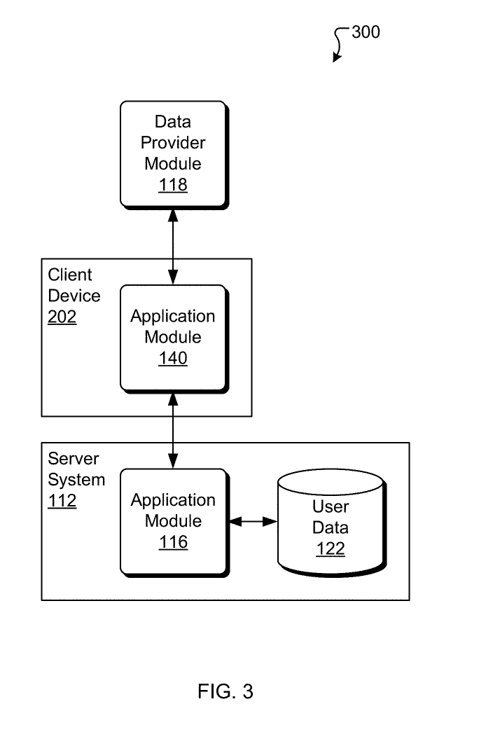

FIG. 3 is a schematic data flow diagram of a similar method 300 in which the application module 140, rather than or in addition to the application module 116, obtains the user information from the data provider module 118. For example, the data provider module 118 can provide the user information to the application module 140 in response to a request from the application module 140. The application module 116 and/or the application module 140 can update or customize the application client according to the user information.

In various examples, the application module 116 and/or the application module 140 can request or obtain user information from the data provider module 118 at periodic intervals (e.g., 1 minute, 5 minute, 1 hour, or 1 day intervals), for example, by making appropriate calls to an API for the data provider module 118. The rate at which user information is obtained can depend on how active a user is in social media. For example, user information can be retrieved more frequently for active social media users. A callback and synchronization mechanism (e.g., TIMERQUEUE) can be used for periodic data retrieval and processing. This can serialize actions such that a queue of events can be ordered and actions can be synchronized by timestamp. The social media information for a user can be obtained when the user first logs in to the application client.

In some examples, the application module 116 and/or the application module 140 can obtain user information using a publish-subscribe platform or other networked messaging technology. For example, the application module 116 and/or the application module 140 can subscribe to one or more channels of a publish-subscribe platform or system that publishes the user information. The publish-subscribe platform can be or include, for example, the SATORI® live data platform provided by Machine Zone, Inc. (http://www.satori.com). Such real-time messaging platforms are preferably capable of transmitting and processing data at or near real-time with low latency. U.S. patent application Ser. No. 15/442,036, filed Feb. 24, 2017, describes a publish-subscribe messaging system and is incorporated by reference herein in its entirety. In some instances, for example, channels can be dedicated to individual users, such that user information for one user can be provided on one channel and user information for another user can be provided on another channel. Other channel configurations are possible. For example, in some examples, a single channel can provide user information for multiple users or groups of users (e.g., associated with particular geographic regions). In alternative examples, user information can be obtained using any suitable real-time messaging platform that is capable of transmitting and processing data at or near real-time with low latency.

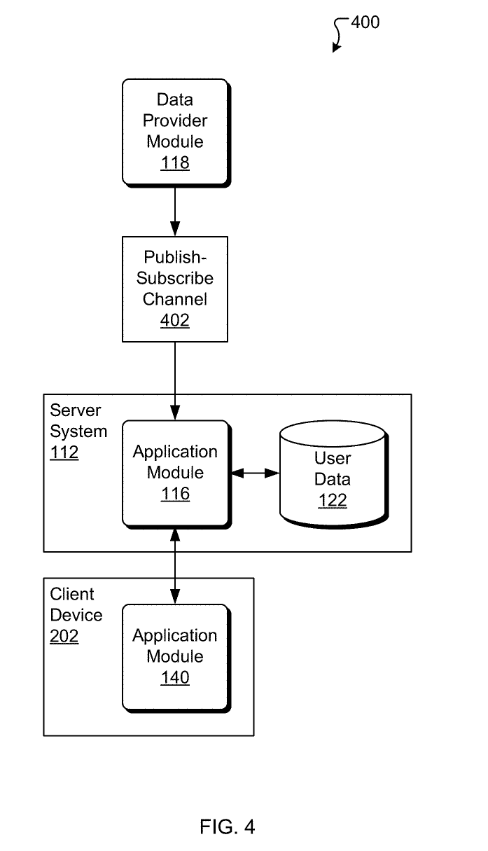

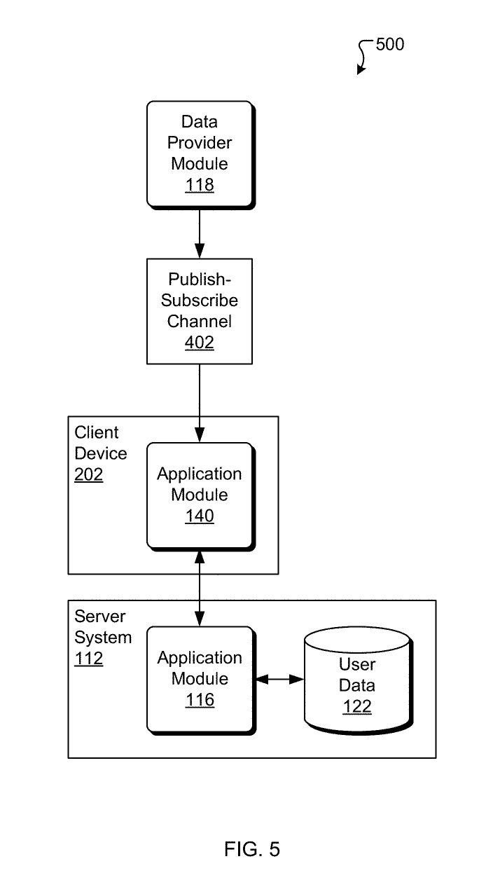

FIG. 4 is a schematic data flow diagram of a method 400 in which the application module 116 obtains user information by subscribing to a channel 402 of a publish-subscribe system. The data provider module 118 publishes the user information to the channel 402, and the application module 116 receives the published information from the channel 402. In an alternative example, FIG. 5 is a schematic flow diagram of a method 500 in which the application module 140 obtains user information by subscribing to the channel 402 of the publish-subscribe system. In this case, the data provider module 118 publishes the user information to the channel 402, and the application module 140 receives the published information from the channel 402. In both methods 400 and 500, the application module 116 and/or the application module 140 can update or customize the application client according to the received user information.

Once the user information has been obtained from the data provider module 118, the application modules 116 and/or 140 can use the information to update or customize the application client for the user. Such customizations can involve adjusting features, functionality, and/or graphical or visual representations of the application client. In some instances, social media user information such as, for example, birthday, gender, age, user preferences, user likes, user status, and the like can be stored for future access in the application client (e.g., in the user data 122 database). When new information is obtained for the user (from the data provider module 118), the new information can be compared with the stored user information. The application client can be updated according to the new information or according to any differences between the new information and the stored information. Systems and methods for designing and managing virtual environments are described in U.S. patent application Publication No. 2018/0196666, published on Jul. 12, 2018, the entire disclosure of which is incorporated by reference herein.

The types of user information that can be used for updating the application client are flexible and varied. In general, any suitable type of social media-related information from any appropriate social media source can be used to enhance the virtual environment experienced by the user in the application client. For example, social media-related information can be obtained from public web services of social media sites that provide such information by exposing APIs. This can allow the backend application server (e.g., the application module 116) and/or the application client (e.g., the application module 140) to retrieve the desired user information by making appropriate API calls. The types of social media-related information can be expanded and/or customized, as desired, according to the application client. In one example, the application modules 116 and/or 140 can adjust the application client on the user's birthday to include, for example, discounts on purchases or changes to how the application client is displayed to the user. Additionally or alternatively, the user's full name can be retrieved from social media and integrated into and/or used to customize the application client. According to exemplary implementations, the application client can be configured to request new social media-related information from the backend application server, or the backend application server can be configured to send the new social media-related information to the application client, for example, in a publish-subscribe channel to which the application client is subscribing. Other methods of providing the social media-related information to the application client are possible.

In various examples, the application client can decide (e.g., based on a set of rules) what to do with the user information and how to apply it to update the features, functionality, and/or graphical or visual representation of the application client. For example, when the application client receives the user's full name, the application client can display the full name in the application client. The user's full name can be presented, for example, in a graphical user interface and/or a popup for the application client. When the application client is or includes a multiplayer online game, the user's full name can be used as a main character name in the game.

Advantageously, the systems and methods described herein can integrate social media-related information from social media sites into the application client, and provide the user with a suitably updated dynamic virtual experience in the application client. A multiplayer game provider can obtain many benefits from this approach. In some instances, for example, the game scene and/or game play can be visually changed based on the user's social media profile. For example, when the user logs in to the game on the user's birthday, the game scene can be changed to show birthday celebration animations and/or virtual gifts. Additionally or alternatively, personal likes or interests of the user, as obtained from social media, can be visually displayed within the virtual environment. For example, if the user's social media data indicates the user likes animals, then animated animals can be added to a virtual field or other part of the virtual environment within the game. In other implementations, the application client can obtain images of users from social media (e.g., from profile pictures) and can present the images in the game. For example, an avatar for a user can incorporate an image of the user (e.g., the user's face or clothing). Additionally or alternatively, the application client can obtain one or more recordings of a user's voice or other sounds from social media. The recordings can be added to the game and presented to other users at desired times. For example, a cheering sound can be played when the user defeats another user, or a booing or screaming sound can be played when the user is defeated. Other sounds retrieved from social media can be played in various game situations.

The application client can, in some instances, modify the online game according to a user's popularity in social media. For example, the game can provide an indication of how many friends or followers a user has in social media. The indication can be or include, for example, distinctive colors, labels, icons, and/or other characteristics displayed on or near the user's avatar in the online game. Users of the game can assess the popularity of other users based on such indications.

Additionally or alternatively, the application client can modify the online game according to social media contacts among the users. For example, when the avatars of two social media friends or followers encounter one another in the online game, one or both avatars can be displayed with labels or other identifiers to indicate that the users are friends or followers. This can encourage the users to interact with one another in the online game. The online game can, in some instances, facilitate interactions among social media contacts. For example, the online game can establish chat sessions for social media friends and/or can encourage such friends to form teams or collaborate in the online game. A new user of the online game can be encouraged to join an existing team or an alliance based on social media contacts present on the team. Alternatively or additionally, the game can allow or prevent users from engaging with social media contacts. For example, in a game of war, a user can be allowed to attack only other users who are friends or only other users who are not friends.

In certain implementations, a user's social media posts or messages can be retrieved and displayed in the online game. When a user posts a message in social media, for example, the message can be automatically reproduced in the online game. Such messages can be presented in chat rooms and/or can be displayed on or near a user's avatar (e.g., in a chat bubble). This can allow the user's social media messages to be presented to other users of the online game, preferably in real time.

In certain examples, the application modules 116 and/or 140 can process the social media user information to determine one or more conditions of the user. The user conditions can be or include, for example, the user's birthday, anniversary, geographical location, relationship status (e.g., married or single), income, wealth, age, health, physical condition, emotional state, an opinion, an attitude, social media contacts, and/or social media popularity. Such information can be determined by processing the user's social media profile and/or interactions, including any messages authored by the user and/or any likes or views of social media content. In some instances, for example, the user's messages can be analyzed to determine one or more user conditions. The user's messages can be semantically analyzed (e.g., with machine learning) to extract one or more conditions for the user. Additionally or alternatively, a sentiment analysis can be performed on the user's messages and/or other social media interactions to determine user sentiment. The sentiment can relate to the user's subjective impressions (e.g., feelings, attitudes, emotions, and/or opinions), rather than facts. For example, the user may be for or against something (e.g., a product or a political view), may like or dislike something, may think something is better than something else, etc. To account for different languages, messages can be translated and/or transformed, as appropriate, prior to performing the semantic and/or sentiment analyses. In one example, when a user's message indicates that the user resides in or is visiting a particular city or country, the application modules 116 and/or 140 can determine a geographical location for the user. Geographical location can be determined using other techniques, such as, for example, cell tower triangulation or IP address identifications. User conditions can be determined periodically, for example, each minute, hour, or day.

In various examples, “gameplay” refers to a way in which users or players can interact with a game (e.g., an online game) and can include how the game is presented with graphical or audio elements. Gameplay can be or include, for example, a plot for the game and/or a user's connection to the plot, a pattern defined by rules for the game, challenges in the game and/or a user's ability to overcome the challenges, a connection between a user and the game (e.g., an ability of the user to interact with a virtual environment for the game), or different graphical/visual representations, behaviors, features, and functionalities to enhance the virtual environment experienced by the user in the game. Gameplay can be governed by a set of rules that can define, for example, (i) a goal of the game, (ii) how a user can interact with the game, and/or (iii) how the game can be modified or adjusted. Alternatively or additionally, gameplay can be distinct from any graphical or audio elements used to present the game.

In various instances, the systems and methods described herein can modify or adjust gameplay for a user of the game, based on one or more conditions of the user, as determined from social media data. Gameplay can be modified, for example, to present the user with a new challenge (or remove a challenge) in the game and/or by making the game more or less difficult. For example, if the application client determines from social media information that the user is experiencing tough times (e.g., poor health, loss of a job, loss of a loved one, etc.), the game can be made less difficult for the user. This can involve, for example, making it easier for the user to acquire and/or retain certain advantages or assets in the game. Additionally or alternatively, gameplay can be adjusted to modify an ability of the user to interact with the virtual environment of the game. This can involve, for example, making it more or less difficult for a user to interact with a virtual environment or with other users (or avatars) in the virtual environment. In some instances, game difficulty can be adjusted by changing one or more gameplay parameters. The gameplay parameters can include or define, for example, a threshold score required to advance to a next game level, an availability of rewards or virtual currency, an availability of virtual assets, a capability of a virtual object or other asset, a capability of a user or the user's avatar in a virtual environment, and/or a frequency and/or intensity of obstacles or challenges (e.g., encounters with other competitors). Systems and methods for adjusting game difficulty are described in U.S. patent application Publication No. 2018/0361254, published on Dec. 20, 2018, the entire disclosure of which is incorporated by reference herein.

Additionally or alternatively, gameplay can be adjusted to modify an availability, type, and/or cost of a virtual item in the game. For example, the application client can provide certain discounts on items the user can purchase using the application client. Such discounts can be provided, for example, when the application client determines from social media that it is the user's birthday. Discounts can be provided in response to changes in one or more user conditions, such as, for example, illness, physical injury, or loss of a job. Additionally or alternatively, gameplay can be adjusted by modifying a type and/or a number of virtual characters or avatars with whom the user can interact in the game. For example, when social media information for a user indicates that the user likes animals, a virtual environment can be modified to include more animals. In some examples, the virtual environment can be modified to include additional or fewer avatars associated with a user's social media contacts (e.g., friends or followers). Additionally or alternatively, gameplay can be adjusted to provide different graphical or visual representations, behaviors, features, and functionalities. This can involve, for example, presenting one or more images from social media in the game. In some examples, a user interface for the game can notify the user that a characteristic of gameplay has been changed. In other examples, one or more gameplay characteristics can be modified without notifying the user.

In various examples, the application client for an online game can be adapted or enhanced based on user conditions, as obtained or determined from social media. The enhanced virtual environment can allow users to experience certain game features and/or have certain capabilities that may not be available outside of the enhanced virtual environment (e.g., in an unenhanced or original virtual environment for the game). For example, the enhanced virtual environment can allow users to view or experience special themes (e.g., colors, decorations, characters, clothing, structures, music, etc.) and/or acquire unique assets (e.g., virtual clothing, gifts, weapons, etc.). Alternatively or additionally, the enhanced virtual environment can allow users to play one or more variations of the online game, for example, according to different rules. The game variations can be more favorable to users in certain respects, when compared to game play in the original virtual environment. For example, the game variations can allow the users to make advancements that may be more difficult to achieve in the original virtual environment.

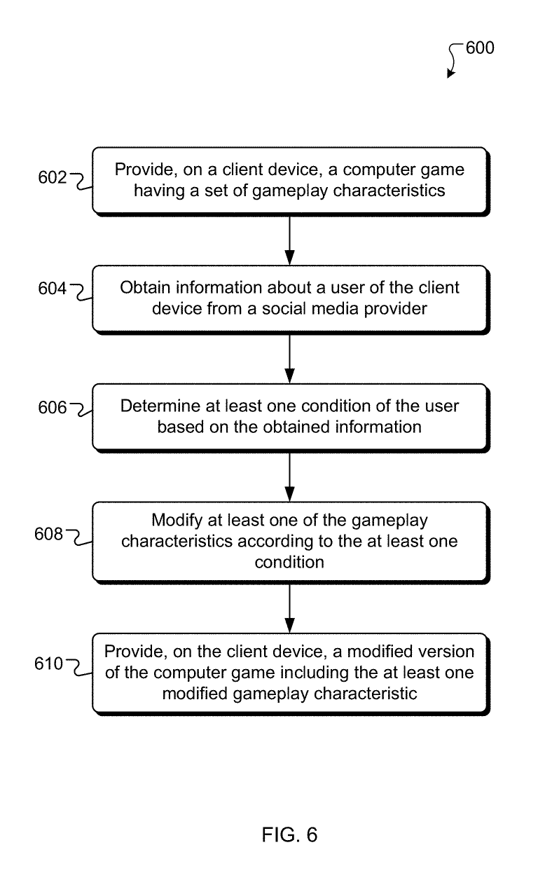

FIG. 6 illustrates an example computer-implemented method of updating an application client based on social media information for users of the application client. A computer game having a set of gameplay characteristics is provided (step 602) on a client device. Information related to a user of the client device is obtained (step 604) from a social media provider. At least one condition of the user is determined (step 606) based on the obtained information. At least one of the gameplay characteristics is modified (step 608) according to the at least one condition. A modified version of the computer game is provided (step 610) on the client device that includes the at least one modified gameplay characteristic.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing, on a client device, a computer game comprising a set of gameplay characteristics;
obtaining information about a user of the client device from a social media provider;
determining at least one condition of the user based on the obtained information;
modifying at least one of the gameplay characteristics according to the at least one condition; and
providing, on the client device, a modified version of the computer game comprising the at least one modified gameplay characteristic.

2. The method of claim 1, wherein the client device comprises at least one of a mobile device and a gaming console.

3. The method of claim 1, wherein the gameplay characteristics comprise at least one of a game rule, a game challenge, a game plot, a virtual item, a game character, or a user ability.

4. The method of claim 1, wherein obtaining the information comprises:
subscribing to a channel of a publish-subscribe system.

5. The method of claim 1, wherein the information comprises at least one of live social media data or social media profile data.

6. The method of claim 1, wherein the step of determining the at least one condition is performed periodically.

7. The method of claim 1, wherein the at least one condition of the user comprises one or more of an anniversary, a birthday, a geographical location, a physical condition, an emotional state, an opinion, an attitude, or a social media popularity.

8. The method of claim 1, wherein modifying at least one of the gameplay characteristics comprises at least one of:
(i) presenting the user with a new challenge in the computer game;
(ii) modifying an ability of the user to interact with a virtual environment of the computer game;
(iii) modifying at least one of an availability, a type, and a cost of a virtual item in the computer game;
(iv) modifying at least one of a frequency and a type of virtual characters in the computer game; or
(v) providing a new graphical representation to enhance the virtual environment of the computer game.

9. The method of claim 1, further comprising:
updating a display of the computer game on the client device according to the determined at least one condition.

10. The method of claim 1, further comprising:
receiving permission from the user of the client device to modify the at least one of the gameplay characteristics according to the at least one condition.

11. A system comprising:
one or more computer processors programmed to perform operations comprising:
providing, on a client device, a computer game comprising a set of gameplay characteristics;
obtaining information about a user of the client device from a social media provider;
determining at least one condition of the user based on the obtained information;
modifying at least one of the gameplay characteristics according to the at least one condition; and
providing, on the client device, a modified version of the computer game comprising the at least one modified gameplay characteristic.

12. The system of claim 11, wherein the gameplay characteristics comprise at least one of a game rule, a game challenge, a game plot, a virtual item, a game character, or a user ability.

13. The system of claim 11, wherein obtaining the information comprises:
subscribing to a channel of a publish-subscribe system.

14. The system of claim 11, wherein the information comprises at least one of live social media data or social media profile data.

15. The system of claim 11, wherein the step of determining the at least one condition is performed periodically.

16. The system of claim 11, wherein the at least one condition of the user comprises one or more of an anniversary, a birthday, a geographical location, a physical condition, an emotional state, an opinion, an attitude, or a social media popularity.

17. The system of claim 11, wherein modifying at least one of the gameplay characteristics comprises at least one of:
(i) presenting the user with a new challenge in the computer game;
(ii) modifying an ability of the user to interact with a virtual environment of the computer game;
(iii) modifying at least one of an availability, a type, and a cost of a virtual item in the computer game;
(iv) modifying at least one of a frequency and a type of virtual characters in the computer game; or
(v) providing a new graphical representation to enhance the virtual environment of the computer game.

18. The system of claim 11, the operations comprising:
updating a display of the computer game on the client device according to the determined at least one condition.

19. The system of claim 11, the operations comprising:
receiving permission from the user of the client device to modify the at least one of the gameplay characteristics according to the at least one condition.

20. An article, comprising:
a non-transitory computer-readable medium having instructions stored thereon that, when executed by one or more computer processors, cause the computer processors to perform operations comprising:
providing, on a client device, a computer game comprising a set of gameplay characteristics;
obtaining information about a user of the client device from a social media provider;
determining at least one condition of the user based on the obtained information;
modifying at least one of the gameplay characteristics according to the at least one condition; and
providing, on the client device, a modified version of the computer game comprising the at least one modified gameplay characteristic.
